(19) United States
(12) Patent Application Publication
(10) Pub. No.: US 2007/0171920 A1
(43) Pub. Date: Jul. 26, 2007

(54) BUFFER MANAGEMENT SYSTEM AND METHOD FOR A MODEM

(75) Inventor: CHUN-LIN CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,640

(22) Filed: Dec. 1, 2006

(30) Foreign Application Priority Data
Jan. 25, 2006 (TW) 95102760

(51) Int. Cl. H04L 12/56

(52) U.S. Cl. 370/397

(57) ABSTRACT

A buffer management method for a modem having virtual circuits is provided. The buffer management method includes steps of: detecting the virtual circuits, and counting the number of virtual circuits in use; collecting the buffers of the modem; and distributing the buffers of the modem to the virtual circuits in use. A buffer management system is also provided.

### BACKGROUND OF THE INVENTION

1. Field of the Invention

The invention relates to a buffer management system and method, and particularly to a buffer management system and method for a modem.

2. Description of related art

In a typical digital subscribed line (DSL) architecture, buffers are set between an asynchronous transfer mode (ATM) interface and an Ethernet interface, for adjusting transmission rate of the ATM interface and the Ethernet interface. Since the ATM connection is divided into more than one virtual circuit (VC), and each virtual circuit occupies a number of the buffers, buffer management is required while multiple permanent virtual circuits (PVCs) are applied in a single ATM channel.

In buffer management it is traditional to allocate a fixed number of buffers for each permanent virtual circuit. For example, if the total number of buffers is 160 and the number of permanent virtual circuits is 8, each of the permanent virtual circuits is allocated 20 buffers. However, in a case that only two of the eight permanent virtual circuits are in use, the remaining 120 buffers are still occupied, and thus, utilization of the buffers is not efficient.

Moreover, since traffic on a permanent virtual circuit transmitting control signaling is far less than that transmitting data, if each permanent virtual circuit is allocated a same number of buffers, a transmission speed of the permanent virtual circuit transmitting data is be decreased.

### SUMMARY OF THE INVENTION

An exemplary embodiment of the invention provides a buffer management system for a modem. The buffer management system includes a detecting module, a collecting module, and a distributing module. The detecting module detects the virtual circuits and counts the number of virtual circuits in use. The collecting module collects the buffers of the modem. The distributing module distributes the buffers of the modem to the virtual circuits in use.

Another exemplary embodiment of the invention provides a buffer management method for a modem having virtual circuits. The buffer management method includes steps of detecting the virtual circuits, and counting the number of virtual circuits in use; collecting the buffers of the modem; and distributing the buffers of the modem to the virtual circuits in use.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic diagram illustrating an application environment of a buffer management system for a modem of an exemplary embodiment of the present invention;

FIG. 2 is a schematic diagram of the buffer management system for the modem of FIG. 1;

FIG. 3 is a flowchart of a buffer management method for a modem of another exemplary embodiment of the present invention; and

FIG. 4 is a flowchart of the buffer management method for a modem of a further exemplary embodiment of the present invention.

### DETAILED DESCRIPTION OF THE INVENTION

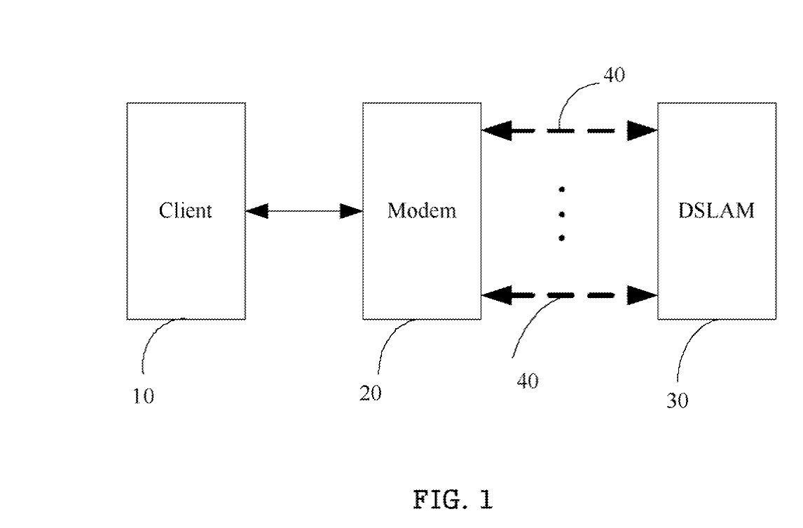

FIG. 1 is a schematic diagram illustrating an application environment of a buffer management system for a modem of an exemplary embodiment of the present invention. A client 10 is connected to a digital subscriber line access multiplexer (DSLAM) 30 via a communication device like an asymmetric digital subscriber line (ADSL) modem 20. The ADSL modem 20 interacts with the DSLAM 30 via a plurality of virtual circuits (VCs) 40. In the exemplary embodiment, the virtual circuits 40 are permanent virtual circuits (PVCs).

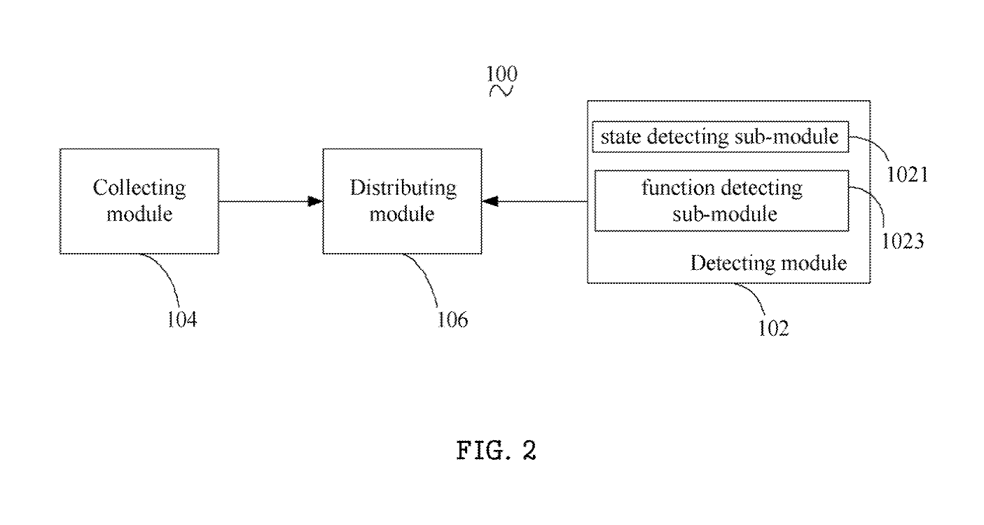

FIG. 2 is a schematic diagram of the buffer management system of FIG. 1. In the exemplary embodiment, the buffer management system 100 is arranged in the modem 20. The buffer management system 100 includes a detecting module 102, a collecting module 104, and a distributing module 106.

The detecting module 102 detects virtual circuits 40 between the ADSL mode 20 and the DSLAM 30, and generates a detected result. In the exemplary embodiment, the detecting module 102 includes a state detecting sub-module 1021 and a function detecting sub-module 1023. The state detecting sub-module 1021 detects states of the virtual circuits 40 and counts the number of the virtual circuits 40 in use. The function detecting sub-module 1023 detects functions of the virtual circuits 40. In the exemplary embodiment, the functions of the virtual circuits 40 include transmitting signaling information and transmitting data.

The collecting module 104 collects buffers of the ADSL modem 20, and transmits a collected result to the distributing module 106.

The distributing module 106 distributes the buffers to the virtual circuits 40 according to the detected result and the collected result. In the exemplary embodiment, the distributing module 106 evenly distributes all buffers of the ADSL modem 20 to the virtual circuit 40 in use. In another exemplary embodiment, the detecting module 102 detects functions and states of the virtual circuits 40 simultaneously, and transmits the detected result to the distributing module 106. The distributing module 106 distributes all buffers of the ADSL modem 20 to the virtual circuits 40 in use according to the detected result. In this embodiment, the buffers distributed to the virtual circuits 40 in use for transmitting signaling information are less than those for transmitting data.

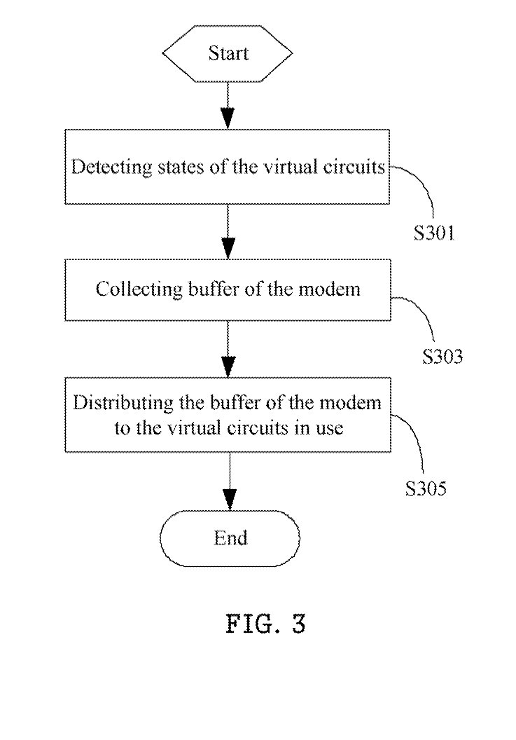

FIG. 3 is a flowchart of a buffer management method for the modem of another exemplary embodiment of the present invention.

In step S301, the detecting module 102 detects the state of the virtual circuits 40 between the ADSL modem 20 and the DSLAM 30 and counts the number of the virtual circuits 40 in use. In the exemplary embodiment, the virtual circuits 40 are permanent virtual circuits 40.

In step S303, the collecting module 104 collects the buffers of the ADSL modem 20.

In step S305, the distributing module 106 distributes the buffers of the ADSL modem 20 to the virtual circuits 40 in use. In the exemplary embodiment, the distributing module 106 evenly distributes all buffers of the ADSL modem to the virtual circuits 40 in use, and does not distribute any buffers to the unused virtual circuits 40.

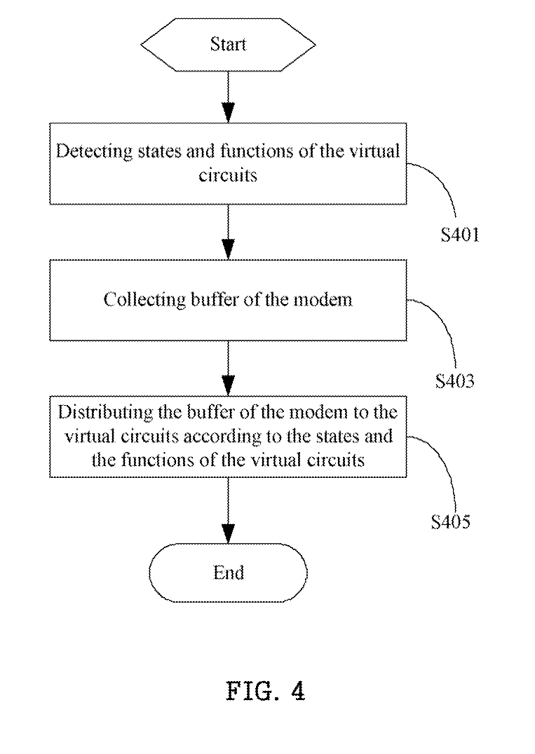

FIG. 4 is a flowchart of the buffer management method for the modem of a further exemplary embodiment of the present invention.

In step S401, the detecting module 102 detects the state and function of the PVCs 40 between the ADSL modem 20 and the DSLAM 30. In the exemplary embodiment, the virtual circuits 40 are permanent virtual circuits 40, the states of the virtual circuits 40 include in-use and not-in-use, and the functions of the virtual circuits 40 include transmitting signaling and transmitting data.

In step S403, the collecting module 104 collects buffers of the ADSL modem 20.

In step S405, the distributing module 106 distributes all buffers of the modem 20 collected by the collecting module 104 to the PVCs 40 according to the state and the function of the PVCs 40 detected by the detecting module 102. In this embodiment, the distributing module 106 distributes the buffers to the PVCs 40 in use, and the buffers distributed to the PVCs 40 in use for transmitting signaling information are less than those for transmitting data.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A buffer management system for a modem having virtual circuits, comprising:
a detecting module for detecting the virtual circuits and counting the number of virtual circuits in use;
a collecting module for collecting buffers of the modem; and
a distributing module for distributing the buffers of the modem to the virtual circuits in use.

2. The buffer management system as claimed in claim 1, wherein the detecting module comprises a function detecting sub-module for detecting functions of the virtual circuits.

3. The buffer management system as claimed in claim 2, wherein the functions of the virtual circuits comprise transmitting signaling information and transmitting data.

4. The buffer management system as claimed in claim 3, wherein the buffers distributed to the virtual circuits in use for transmitting signaling information are less than those for transmitting data.

5. The buffer management system as claimed in claim 1, wherein the detecting module comprises a state detecting sub-module for detecting states of the virtual circuits.

6. The buffer management system as claimed in claim 5, wherein the states of the virtual circuits comprise in-use and not-in-use.

7. A buffer management method for a modem having virtual circuits comprising steps of:
detecting states of the virtual circuits and counting the number of virtual circuits in use;
collecting the buffers of the modem; and
distributing the buffers of the modem to the virtual circuits in use.

8. The buffer management method as claimed in claim 7, further comprising detecting functions of the virtual circuits.

9. The buffer management method as claimed in claim 8, wherein the functions of the virtual circuits comprise transmitting signaling information.

10. The buffer management method as claimed in claim 9, wherein the functions of the virtual circuits comprise transmitting data.

11. The buffer management method as claimed in claim 10, further comprising distributing the buffers according to functions of the virtual circuits.

12. The buffer management method as claimed in claim 11, wherein the buffers distributed to virtual circuits in use for transmitting signaling information are less than those for transmitting data.

13. The buffer management method as claimed in claim 7, wherein the virtual circuits are permanent virtual circuits.

14. The buffer management method as claimed in claim 7, wherein the modem is an asymmetric digital subscriber line modem.

15. A method for managing buffers of a communication device, comprising steps of:
providing a plurality of virtual circuits in a communication device to communicate data for said communication device by means of using buffers of said communication device, respectively;
detecting corresponding states of said plurality of virtual circuits of said communication device;
collecting said buffers of said communication device; and
distributing said buffers of said communication device to each of said plurality of virtual circuits according to said detected states of said plurality of virtual circuits and said collected buffers.

16. The method as claimed in claim 15, wherein an in-use number of said plurality of virtual circuits is retrieved in said step of state-detecting.

17. The method as claimed in claim 15, wherein function of said each of said plurality of virtual circuits is retrieved in said step of state-detecting.
